(19) United States
(12) Patent Application Publication
(10) Pub. No.: US 2008/0292805 A1
(43) Pub. Date: Nov. 27, 2008

(54) METHOD FOR MANUFACTURING STAMPER, METHOD FOR MANUFACTURING NANOHOLE STRUCTURE, AND METHOD FOR MANUFACTURING MAGNETIC RECORDING MEDIUM

(75) Inventors: Hiroaki Tamura, Kawasaki (JP); Mitsuo Takeuchi, Kawasaki (JP); Ken-ichi Itoh, Yamato (JP); Hideyuki Kikuchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/121,218

(22) Filed: May 15, 2008

(30) Foreign Application Priority Data
May 25, 2007 (JP) 2007-139383

(51) Int. Cl. B05D 1/24

(52) U.S. Cl. 427/443.2

(57) ABSTRACT

According to an aspect of an embodiment, a method for manufacturing a stamper for duplicating a pit pattern on a substrate includes forming on another substrate, a layer of a material insoluble to a liquid of a suspension of particles in a pattern having a plurality of land portions and a plurality of groove portions between the land portions, and dipping the another substrate having the layer of the material having the pattern in the liquid of the suspension of the particles so that the particles are adhered to the groove portions. The-method further includes forming a mold having a plurality of pits corresponding to the particles by transferring the shapes of the particles on the another substrate to the mold, and forming a stamper having a plurality of protrusions corresponding to the pits by transferring the shapes of the pits of the molds to the stamper.

### BACKGROUND

This art relates to a method for manufacturing a stamper suitably used in the manufacture of a nanohole structure suitable for magnetic recording media and the like, a method for manufacturing a nanohole structure using the stamper, and a method for manufacturing a magnetic recording medium using the stamper.

Examples of arts related to the method for manufacturing the stamper, the method for manufacturing the nanohole structure, and the method for manufacturing the magnetic recording medium are discussed in Japanese Laid-open Patent Publications No. 10-121292 and No. 2006-346820.

### SUMMARY

According to an aspect of an embodiment, a method for manufacturing a stamper for duplicating a pit pattern on a substrate includes: forming on another substrate, a layer of a material insoluble to a liquid of a suspension of particles in a pattern having a plurality of land portions and a plurality of groove portions between the land portions; dipping the another substrate having the layer of the material having the pattern in the liquid of the suspension of the particles so that the particles are adhered to the groove portions; forming a mold having a plurality of pits corresponding to the particles by transferring the shapes of the particles on the another substrate to the mold; and forming a stamper having a plurality of protrusions corresponding to the pits by transferring the shapes of the pits of the molds to the stamper.

### BRIEF DESCRIPTION OF THE DRAWINGS

FIGS. 1A to 1C are schematic views of an arrangement of particles formed on a substrate;

FIGS. 2A to 2D are schematic cross-sectional views of a step of forming a land and groove pattern according to an embodiment;

FIGS. 3A and 3B are schematic cross-sectional views of a step of forming a land and groove pattern according to another embodiment;

FIGS. 4A to 4C are schematic cross-sectional views of a step of forming a land and groove pattern according to still another embodiment;

FIGS. 5A to 5C are schematic cross-sectional views of a step of forming an arrangement of particles by a pulling method;

FIGS. 6A to 6E are schematic cross-sectional views of a step of transferring a pattern;

FIGS. 7A to 7K are schematic cross-sectional views of a method for forming a starting point of nanohole;

FIGS. 8A and 8B are schematic cross-sectional views of a step of forming a nanohole on a metal substrate by anodizing;

FIG. 9 is a schematic cross-sectional view of a magnetic recording medium manufactured by a method for manufacturing a magnetic recording medium according to an embodiment;

FIG. 10 is an enlarged schematic cross-sectional view of the magnetic recording medium illustrated in FIG. 9; and

FIGS. 11A to 11I are schematic cross-sectional views of a process for manufacturing a magnetic recording medium according to an embodiment.

### DESCRIPTION OF THE PREFERRED EMBODIMENTS

Recently, research and development on the formation of fine structures on the order of nanometers has been conducted actively. For example, such fine structure is applied to magnetic recording media having high recording density.

Magnetic recording media have utilized in-plane recording on a continuous magnetic film. Thus, various techniques for reducing the size of magnetic particles contained in the continuous magnetic film have been developed to increase the packaging density. However, the packaging density of in-plane magnetic recording media is approaching its limit. Research is therefore actively going on to develop new recording methods to replace the in-plane recording method. Above all, a recording method utilizing a patterned medium has been studied actively. The patterned medium has, in place of a continuous magnetic film, a pattern, such as a dot pattern, that has a single magnetic domain structure on the order of nanometers.

In the manufacture of the patterned medium, various methods have been studied to form a pattern on the order of nanometers over the entire surface of a medium on the order of inches with high precision and at low cost.

The pits are formed, for example, by directly pressing a stamper having a fine structure thereon against the aluminum substrate or by applying a resin to the aluminum substrate, pressing a stamper against the resin, and transferring a fine-structure pattern to the aluminum substrate by etching.

A method for arranging particles on the order of nanometers on a substrate has been studied to efficiently manufacture a stamper having a fine structure thereon.

Lands and grooves may be efficiently formed on a substrate by forming a resin layer on the substrate, patterning the resin layer by an imprint method using a mold, and etching the substrate. Alternatively, lands and grooves may be formed by forming a photoresist layer on a substrate, patterning the photoresist layer by photolithography, and etching the substrate.

Particles may be arranged on lands and grooves by a pulling method or a centrifugation method. In the pulling method, a substrate dipped in a liquid of a suspension of particles is pulled up at a low speed to arrange particles at an interface between the substrate and the liquid of the suspension of the particles. In the centrifugation method, while a substrate is being dipped in a liquid of a suspension of particles, the particles are deposited on the substrate by centrifugal force.

However, dipping a substrate that has lands and grooves formed of a resin in a liquid of a suspension of particles may cause the resin to dissolve in the liquid, become detached from the substrate, or form cracks. These defects increase with the area of the resin applied to the substrate. A substrate is dipped in a liquid of a suspension of particles for a longer period of time in the pulling method than in the centrifugation method. Thus, in a method for manufacturing a stamper for use in the production of magnetic recording media on the order of inches, the pulling method may result in lands and grooves of an irregular shape.

Because particles cannot be arranged appropriately on lands and grooves of an irregular shape, the resulting stamper cannot have a designed shape. Furthermore, magnetic recording media manufactured with such a stamper often cause a recording or reproducing error in a magnetic recorder.

A method for manufacturing a stamper according to an embodiment relates to a manufacturing method of a stamper for duplicating a land and groove pattern on another substrate. A method for manufacturing a nanohole structure according to an embodiment relates to a method for forming a nanohole structure using a stamper manufactured by the method for manufacturing a stamper, wherein different arrangements of nanoholes are formed repeatedly. A method for manufacturing a magnetic recording medium according to an embodiment relates to a method for manufacturing a magnetic recording medium using a stamper manufactured by the method for manufacturing a stamper, wherein a plurality of nanoholes formed on a substrate contains a magnetic material. These manufacturing methods will be described below with embodiments.

### 1. Method for Manufacturing a Stamper

A method for manufacturing a stamper according to an embodiment includes the steps of forming a land and groove pattern; forming an arrangement of particles on the land and groove pattern; and transferring the arrangement of particles to the stamper.

First, a stamper manufactured by a method for manufacturing a stamper according to the present embodiment will be described.

This stamper is used in the manufacture of a nanohole structure described below, and has a land and groove pattern thereon. The land and groove pattern is duplicated on a substrate in which a nanohole structure is to be formed. The stamper may be formed of any material and have any shape, structure, and size; these are appropriately determined for each purpose.

The stamper may be, but not limited to, plate-shaped or discoidal. When the nanohole structure is used for a magnetic recording medium, such as a hard disk, the stamper is preferably discoidal.

Nanoholes (pores) formed with a plate-shaped or discoidal stamper in a metal substrate having a nanohole structure are formed approximately at right angles to a surface of the metal substrate.

The size of the stamper is not limited to a particular size, and may be appropriately selected for each purpose. When the nanohole structure formed with the stamper is used for a magnetic recording medium, such as a hard disk, the stamper preferably has a size matching the size of existing hard disks. When the nanohole structure is used for a DNA chip, the stamper preferably has a size matching the size of existing DNA chips. When the nanohole structure is used for a catalyst substrate, such as a carbon nanotube, for use in a field-emission apparatus, the stamper preferably has a size matching the size of the field-emission apparatus.

An arrangement of particles formed on a substrate by a step of forming an arrangement of particles according to the present embodiment is transferred to the stamper to form a land and groove pattern on the stamper.

An arrangement of particles is formed by arranging particles on a substrate having a land and groove pattern. In the present embodiment, the arrangement of particles may be, but not limited to, a plurality of arrangements of particles parallel to each other, a concentric arrangement, or a spiral arrangement. The arrangement of particles may be a regular arrangement, in which particles are regularly arranged on a substrate, or an irregular arrangement, in which particles are irregularly arranged on a substrate.

When a stamper manufactured in the present embodiment has an arrangement of particles that includes a regular arrangement and another arrangement (for example, an irregular arrangement) adjacent to the regular arrangement, the resulting nanohole structure has both of the arrangements.

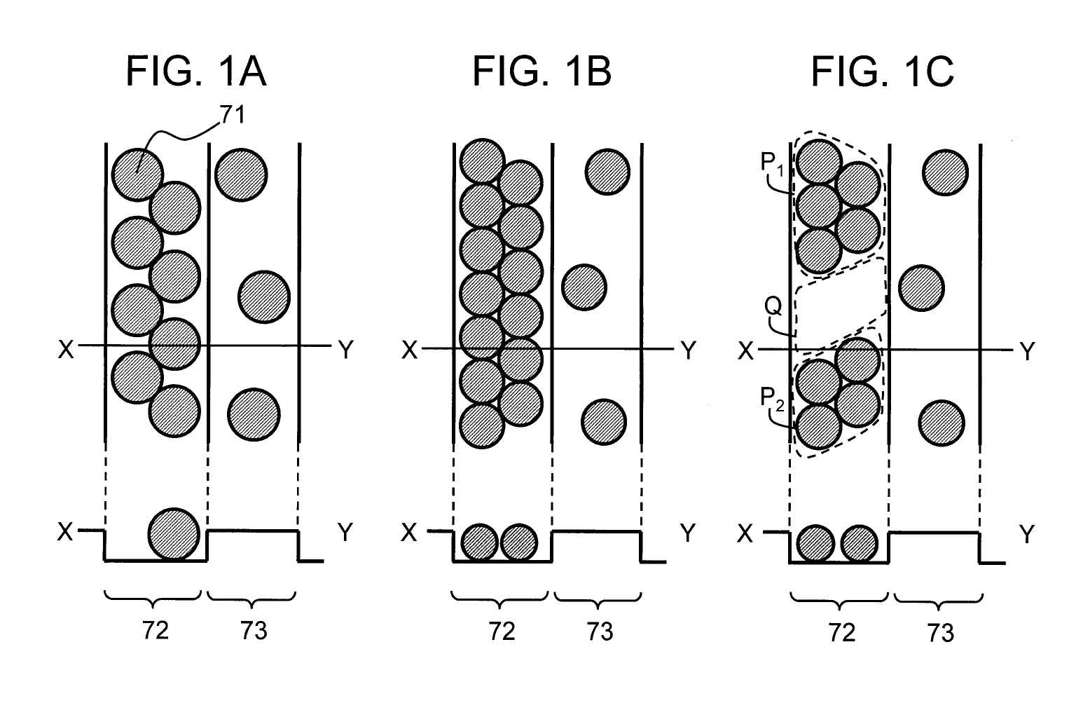

The term “regularly arranged”, as used herein, means that particles are disposed at regular intervals in at least one axial direction. The axis may be straight or curved. FIGS. 1A to 1C are schematic views of an arrangement of particles formed on a substrate. Each of FIGS. 1A to 1C includes a plan view (upper part) and a cross-sectional view (lower part) taken along line X-Y.

In FIGS. 1A and 1B, a groove 72 has a regular arrangement, and a land 73 has an irregular arrangement. In the groove 72, particles are arranged at regular intervals. In FIG. 1B, particles in the groove 72 are close-packed.

FIG. 1C illustrates another arrangement of particles. The arrangement of particles in a groove 72 in FIG. 1C includes regular arrangements P₁ and P₂ and an irregular arrangement Q, and has a so-called domain structure. In the present embodiment, such an arrangement is not considered to be a regular arrangement.

Such a nanohole structure can be used for a magnetic recording medium, such as a hard disk. The regular arrangement functions as a data area, and another arrangement adjacent to the regular arrangement functions as a guard band area. These different arrangements make tracking easier.

The steps of a method for manufacturing a stamper according to the present embodiment will be described below. (Step of forming a land and groove pattern)

In a step of forming a land and groove pattern, the land and groove pattern is formed on a substrate using a material that does not dissolve in a liquid of a suspension of particles described below. The land and groove pattern formed using such a material does not dissolve in the suspension of particles in a step of forming an arrangement of particles described below. Thus, the land and groove pattern is maintained.

The material of the substrate is not limited to a particular material, and may be appropriately selected for each purpose. Examples of the material of the substrate include silicon (Si), silicon oxide, silicon nitride, silicon carbide, metals, metal oxides, metal nitrides, and metal carbides. Furthermore, various polymers, Si, metals, metal oxides, glasses, and ceramics each having a surface formed of the material described above may be used.

The substrate may have any shape suitable for each purpose, and is generally a plate, but may be a sheet or a film.

A patterning material that forms the land and groove pattern may be any material that does not dissolve in the liquid of the suspension of the particles. Preferably, the patterning material contains at least one material selected from the group consisting of Si, silicon oxide, silicon nitride, silicon carbide, metals, metal oxides, metal nitrides, and metal carbides.

The land and groove pattern formed of the patterning material maintains its shape mainly by a covalent bond or a metal bond. In a step of forming an arrangement of particles described below, therefore, the liquid of the suspension of the particles cannot cleave the bond to disintegrate the structure. Thus, the land and groove pattern does not change during the step of forming an arrangement of particles.

When lands are formed of a resin, the lands maintain the shape by intermolecular force between polymer molecules of the resin. The bond based on the intermolecular force is weaker than the covalent bond or the metal bond. Thus, a dispersion medium, such as water, or an additive agent, such as a surfactant, in the liquid of the suspension of the particles can penetrate into carbon chains and molecules of the polymer. Dipping a pattern formed of a resin in the liquid of the suspension of the particles for a long period of time may cause the pattern to dissolve in the liquid of the suspension, become detached from the substrate, or form cracks. In particular, when the lands have a half-width of 80 nm or less, the pattern tends to dissolve in the liquid of the suspension, become detached from the substrate, or form cracks.

The width of a land in the land and groove pattern is not limited to a particular value, and may be appropriately selected for each purpose. A stamper according to the present embodiment rarely dissolves in the liquid of the suspension, become detached from the substrate, or form cracks, even when the lands have a half-width of 80 nm or less, particularly in the step of forming a land and groove pattern.

At present, the lower limit of the half-width of land is about 10 nm because of the precision of chemical mechanical polishing (CMP) or etching.

The shape of a cross section of lands and grooves may be any shape suitable for each purpose, and may be quadrilateral, V-shaped, or semicircular. Among these, quadrilateral is preferred because particles can easily be arranged on the land and groove pattern.

Preferably, the substrate is formed of Si or silicon oxide, and the patterning material is Si or silicon oxide. In this combination, both the substrate and the land and groove pattern contain Si. When both the substrate and the land and groove pattern contain an element of the same group, the adhesiveness between the substrate and the land and groove pattern is improved. This prevents the land and groove pattern from being detached from the substrate in a step of forming an arrangement of particles described below.

The substrate and the patterning material may also be selected according to the design of the arrangement of particles formed on the land and groove pattern.

Particles in the liquid of the suspension generally have a self-assembling ability. The term “self-assembling ability”, as used herein, means that particles in a liquid of a suspension of particles assemble regularly on a substrate dipped in the liquid of the suspension of the particles as dispersion liquid vaporizes from the substrate.

In general, when a substrate having a land and groove pattern is dipped in a liquid of a suspension of particles, a liquid meniscus bridge tends to be formed in grooves. The liquid meniscus bridge is strongly adsorbed on the grooves. Particles will therefore be regularly arranged in the grooves. However, when only the shape of lands and grooves is controlled, particles are sometimes arranged irregularly in part of the grooves (resulting in a domain structure).

Silicon oxide, such as glass, or a metal oxide is preferably used as the material of the substrate to arrange particles regularly in the grooves. The reason for that is as follows. Silicon oxide and metal oxides generally have a contact angle with water of 30° or less, and have relatively high wettability with water. Since a liquid of a suspension of particles generally contains a large quantity of water as a dispersion medium, silicon oxide and metal oxides also have relatively high wettability with the liquid of the suspension of the particles. The self-assembling ability of particles in the suspension of the particles is therefore negligibly reduced in the grooves. Thus, the particles are arranged regularly.

When it is desirable to disperse particles irregularly on a land, the patterning material is preferably Si or a metal. Si or a metal generally has a contact angle with water of at least 60°, and has wettability with an aqueous suspension of particles lower than that of a substrate formed of silicon oxide or a metal oxide. Particles are therefore difficult to attach to a land, and it is difficult to form a regular arrangement on the land. Examples of the metal include Ta, Al, and W.

When a regular arrangement of particles formed on grooves and an irregular arrangement of particles formed on lands are transferred to a stamper, the stamper has a surface profile in which the regular arrangement and the irregular arrangement are disposed alternately. A magnetic recording medium manufactured by using such a stamper includes nanoholes corresponding to the regular arrangement, which function as a data area, and nanoholes corresponding to the irregular arrangement, which function as a guard band area. These different arrangements make tracking easier.

A land and groove pattern that includes lands formed of a patterning material may be formed on a substrate by any method, including a method described below.

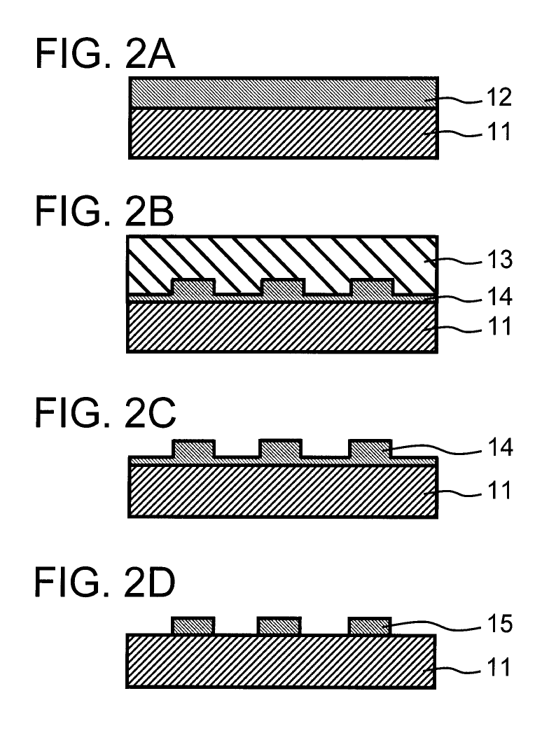

FIGS. 2A to 2D, FIGS. 3A and 3B, and FIGS. 4A to 4C are schematic cross-sectional views of a step of forming a land and groove pattern according to an embodiment. A resin solution is applied to a substrate 11, such as a silicon wafer that has an oxide film thereon, by spin coating. The substrate 11 is heated to evaporate the solvent, thus forming a resin layer 12 on the substrate 11 (FIG. 2A). The resin may be, but not limited to, a thermoplastic polymer, such as polymethyl methacrylate (PMMA), or a resist resin.

A mold 13 that has grooves having a predetermined depth disposed at predetermined intervals is pressed against a substrate 11, which is heated above the glass transition temperature of the resin applied to the substrate 11 (FIG. 2B). The grooves of the mold 13 correspond to lands of a stamper. The mold 13 is then separated from the resin layer 12 to transfer the mold pattern as a land and groove pattern 14 on the resin layer 12 (FIG. 2C).

The mold 13 may be manufactured by any method, including the following method. First, a resist is applied to a silicon wafer, is irradiated with an electron beam (EB), and is developed to form a resist pattern on the silicon wafer. The silicon wafer is etched using the resist pattern as a mask, thus forming the mold 13.

The steps illustrated in FIGS. 2A to 2C are called imprint. The substrate 11 having the land and groove pattern 14 is then etched to remove the resin at the grooves, thus exposing the oxide film. This leaves lands 15 formed of the resin on the substrate 11 (FIG. 2D).

Lands formed of a patterning material are then formed on the substrate 11, which has the lands 15 formed of the resin, as illustrated in FIG. 2D. The lands formed of a patterning material may be formed by a method involving lift-off or chemical mechanical polishing (CMP). These methods can control the height of land more precisely than imprint or etching. Thus, the lands can have substantially the same height over the entire substrate.

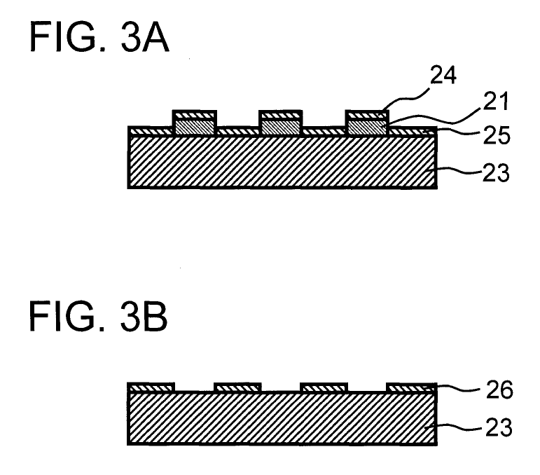

A method for forming lands by lift-off will be described below with reference to FIGS. 3A and 3B.

First, as illustrated in FIG. 3A, patterning material layers 24 and 25 are formed on the substrate 11 having the resin lands 15 illustrated in FIG. 2D (reference numeral 21 and 23 in FIG. 3A). The method for forming the patterning material layers 24 and 25 may be, but not limited to, vapor deposition, sputtering, or chemical vapor deposition (CVD), selected according to the patterning material. Among others, sputtering is preferred in terms of adherence. In sputtering, atoms are deposited on a substrate at high energy. The thickness of the patterning material layers 24 and 25 is preferably one-half, more preferably one third, of the height of the resin lands 21 disposed on a substrate 23, in view of a downstream lift-off process.

The patterning material layers 24, together with the resin lands 21, are then removed by lift-off (FIG. 3B). A remover used in lift-off may be any solvent that can dissolve the resin, including organic solvents, such as acetone and xylene. The patterning material layers 25, which are formed directly on an oxide film disposed on the substrate 23, are not dissolved in an organic solvent, and therefore remain on the substrate while maintaining their shape, thus forming lands 26 formed of the patterning material.

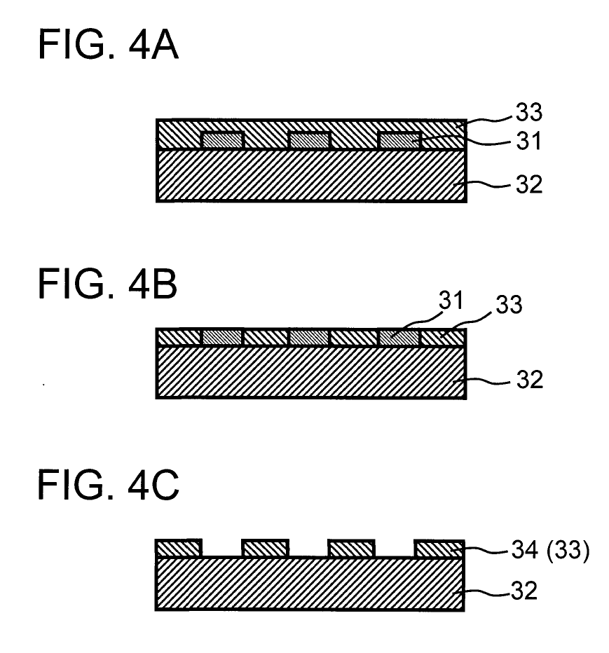

A method for forming lands by chemical mechanical polishing will be described below with reference to FIGS. 4A to 4C.

First, as illustrated in FIG. 4A, a patterning material layer 33 are formed on the substrate 11 having the resin lands 15 illustrated in FIG. 2D (reference numeral 31 and 32 in FIG. 4A). The method for forming the patterning material layer 33 may be any method, and is selected according to the material, as in the step of forming the layered product illustrated in FIG. 3A. The thickness of the patterning material layer 33 is more than the height of the resin lands 31.

The patterning material layer 33 that is formed on the substrate 32 having the resin lands 31 is then ground by chemical mechanical polishing to expose the top of the resin lands 31 (FIG. 4B). The resin lands 31 are then removed to form lands 34 formed of the patterning material on the substrate 32 (FIG. 4C). The resin lands 31 may be removed by dissolving the resin lands 31 with an organic solvent, such as acetone or xylene, or by dry-etching involving oxygen plasma ashing.

### (Step of Forming an Arrangement of Particles)

In a step of forming an arrangement of particles, a substrate that has a land and groove pattern formed by the step of forming a land and groove pattern is dipped in a liquid of a suspension of particles to arrange the particles on the surface of the land and groove pattern. As described above, the lands formed of a material that is not dissolved in a liquid of a suspension of particles are formed on the substrate in the step of forming a land and groove pattern. In the present embodiment, therefore, the lands formed on the substrate maintain their shape in this step. Thus, an arrangement of particles is formed in the grooves and on the lands as intended (as designed).

A liquid of a suspension of particles contains particles dispersed in dispersion liquid.

The material of the particles may be appropriately selected for each purpose, and preferably includes at least one selected from the group consisting of organic polymers, metals, metal oxides, and metal hydroxides. More specifically, the material of the particles preferably includes at least one selected from the group consisting of polystyrene, silica, indium tin oxide (ITO), and gold. In particular, when the substrate is a silicon oxide substrate or a metal oxide substrate, silica particles are preferred, because the silica particles are easily arranged in grooves of a land and groove pattern. Organic polymer particles, metal oxide particles, or metal hydroxide particles may be coated with ITO or gold.

The shape of the particles is not limited to a particular shape, and may be appropriately selected for each purpose. When a stamper manufactured by the method for manufacturing a stamper according to the present embodiment is used in the manufacture of a nanohole structure described below, the particles are preferably spherical, because spherical particles can form starting points for forming nanoholes described below, and because a monolayer of close-packed particles can be formed easily.

The size of the particles is not limited to a particular size, and may be appropriately selected for each purpose. When a stamper manufactured by the method for manufacturing a stamper according to the present embodiment is used in the manufacture of a nanohole structure described below, the average size of the particles is preferably substantially the same as the predetermined nanohole pitch, for example, preferably in the range of 5 to 100 nm and more preferably in the range of 5 to 25 nm, because starting points for forming nanoholes can be formed. When the average size of the particles is less than 5 nm, it may be difficult to form nanoholes at a predetermined pitch by subsequent anodic oxidation. When the average size of the particles is more than 100 nm, a magnetic disk may have insufficient capacity.

The particle size distribution of the particles is not limited to a particular range, and may be appropriately selected for each purpose. The particles preferably have a coefficient of variation as small as possible. For example, the coefficient of variation of the particles is preferably 10% or less, more preferably 5% or less, and most preferably 0%.

The coefficient of variation indicates the variation in measured value relative to the mean value, and is calculated using Equation (1):

Cv(%)=σ/<X>×100 (1)

wherein Cv denotes the coefficient of variation, σ denotes the standard deviation, and <X> denotes the mean value.

The coefficient of variation of the particles of more than 10% may result in low in-plane crystallinity of the particles. In a magnetic recording medium, such as a hard disk, having such a nanohole structure, this may result in low periodicity of a magnetic signal pulse generated from a magnetic layer formed in a nanohole, leading to a low S/N ratio.

A dispersion liquid contains a dispersion medium and an optional additive agent, such as a surfactant.

The dispersion medium is preferably, but not limited to, water or ethanol.

The surfactant may be an anionic, cationic, nonionic, or zwitterionic surfactant.

The anionic surfactant may be a long-chain alkyl having a functional group, such as a sulfate group, a phosphate group, a carboxylic acid group, or a sulfonic acid group. More specifically, the anionic surfactant may be sodium dodecyl sulfate.

The cationic surfactant may be a long-chain alkyl having a functional group, such as an amine group or a quaternary ammonium group. More specifically, the cationic surfactant may be an alkyl trimethylammonium chloride.

The nonionic surfactant may be an alkyl ester or an alkyl ether. More specifically, the nonionic surfactant may be a polyoxyethylene alkyl ether.

The dispersion liquid may contain, as an additive agent, a polymer, such as polystyrene, and a salt, such as sodium azide, as well as a surfactant.

The method for dipping a substrate having a land and groove pattern in a liquid of a suspension of particles may be appropriately selected for each purpose, and may be, but not limited to, a pulling method or a centrifugation method. The pulling method is preferred in terms of the arrangement of particles.

In the pulling method, a substrate is dipped in a liquid of a suspension of particles, and is then mechanically pulled up to adhere the particles on the substrate.

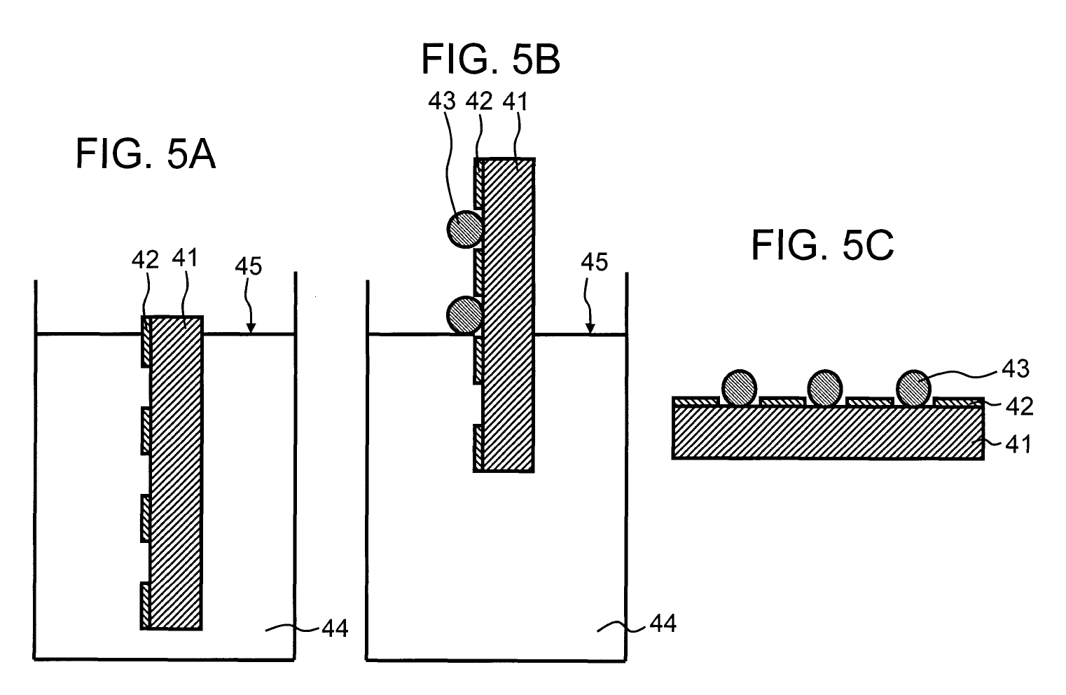

FIGS. 5A to 5C are schematic cross-sectional views of a step of forming an arrangement of particles by a pulling method. A substrate 41 illustrated in FIGS. 5A to 5C corresponds to the substrate 23 in FIGS. 3A and 3B and the substrate 32 in FIGS. 4A to 4C. Lands 42 formed of a patterning material illustrated in FIGS. 5A to 5C correspond to the lands 26 in FIGS. 3A and 3B and the lands 34 in FIGS. 4A to 4C. First, the substrate 41, which has the lands 42 formed of a patterning material, is dipped into a liquid of a suspension of particles 44 perpendicularly to the surface 45 of the liquid of the suspension 44 (FIG. 5A). The substrate 41 is then mechanically pulled up from the liquid of the suspension of the particles 44 perpendicularly to the surface 45 of the liquid of the suspension 44. Particles are arranged on the substrate 41 at the surface 45 of the liquid of the suspension of particles 44 (FIG. 5B).

The speed of pulling up the substrate 41 is not limited to a particular value, and may be appropriately selected for each purpose. Preferably, the speed is relatively low. For example, when the liquid of the suspension of particles 44 contains 1% by mass of particles having an average size of 60 nm, the speed of pulling up the substrate 41 is preferably in the range of 0.03 to 0.1 mm/min. This allows the particles to form a monolayer on the substrate 41. At such a low speed, although the lands 42 are dipped in the liquid of the suspension of particles 44 for a long period of time, the lands 42 maintain their shape.

While a substrate having resin lands is pulled up from a liquid of a suspension of particles, the resin lands may dissolve in the liquid of the suspension, become detached from the substrate, or form cracks. However, in a substrate having metal lands, the metal lands have negligible stress cracks and are not dissolved in the liquid of the suspension of particles. Thus, the substrate can be pulled up from the liquid of the suspension of particles without causing any defect in a land and groove pattern of the substrate.

In the centrifugation method, a substrate is dipped in a liquid of a suspension of particles and is centrifuged to press the particles onto the substrate, thus forming a film of particles. More specifically, a liquid of a suspension of particles is charged, for example, into a centrifuge tube; a substrate is placed at the bottom of the centrifuge tube; and the centrifuge tube is rotated to form a particle monolayer on the substrate.

In a centrifugation method using a centrifuge, the number of revolutions of the centrifuge may be appropriately selected for each purpose and is preferably at least 15,000 rpm (13,000 G).

At the number of revolutions of less than 15,000 rpm, the particle monolayer may not be close-packed.

The time of rotation of a centrifuge may be appropriately selected for each purpose and is preferably in the range of 5 to 120 minutes and more preferably in the range of 5 to 60 minutes.

At a time of rotation of less than five minutes, the particle monolayer may not be close-packed. A time of rotation of more than 120 minutes may be more than sufficient in terms of throughput, because most of the particles in a dispersion may be precipitated within 120 minutes.

The arrangement of particles to be formed on a substrate is not limited to a particular arrangement, and may be appropriately selected for each purpose. FIG. 5C is a schematic cross-sectional view of an arrangement of particles formed by the present step. This arrangement of particles includes particles 43 arranged in grooves between the lands 42 formed of a patterning material. There is no particle on the lands 42.

Thus, a monolayer of particles is formed on a land and groove pattern of a substrate.

### (Step of Transferring a Pattern)

In a step of transferring a pattern, an arrangement of particles formed by the step of forming an arrangement of particles is transferred to a material for the formation of a stamper. The step of transferring a pattern includes a first transfer substep and a second transfer substep. In the first transfer substep, the arrangement of particles is transferred to a mold as the reverse pattern. In the second transfer substep, the reverse pattern of the mold is transferred to a stamper as a land and groove pattern.

Each of the first transfer substep and the second transfer substep is generally performed once to form a stamper. Furthermore, in the second transfer substep, the mold manufactured in the first transfer substep may be used more than once to transfer the mold pattern to a plurality of materials for the formation of a stamper, thus forming a plurality of stampers. Each of the stampers may be further used in the first transfer substep as a mold. In this case, the number of times the first transfer substep is carried out is smaller than that of the second transfer substep.

In the step of forming an arrangement of particles, an arrangement of particles is formed on each of grooves and lands of a substrate as intended. The arrangement of particles can be transferred to a material for the formation of a stamper to form a stamper having a land and groove pattern as intended (as designed).

The material for the formation of a stamper used in the second transfer substep may be appropriately selected for each purpose, and may be a photocurable polymer, Ni, SiC, Si, or SiO₂. These materials may be used alone or in combination. Among these, Ni is preferred, because Ni has high durability in a continuous operation, and a plurality of stampers can easily be duplicated from a single Ni master stamper.

The photocurable polymer may be appropriately selected for each purpose, and may be a photocurable acrylic resin or a photocurable epoxy resin. Among these, a photocurable acrylic resin is preferred in terms of transferability and flowability.

The material for the formation of a stamper is selected according to a method for forming starting points for forming nanoholes in a metal substrate in a method for manufacturing a nanohole structure described below.

The material of a mold used in the first transfer substep may be appropriately selected for each purpose, and may be a photocurable polymer, Ni, SiC, Si, or SiO₂.

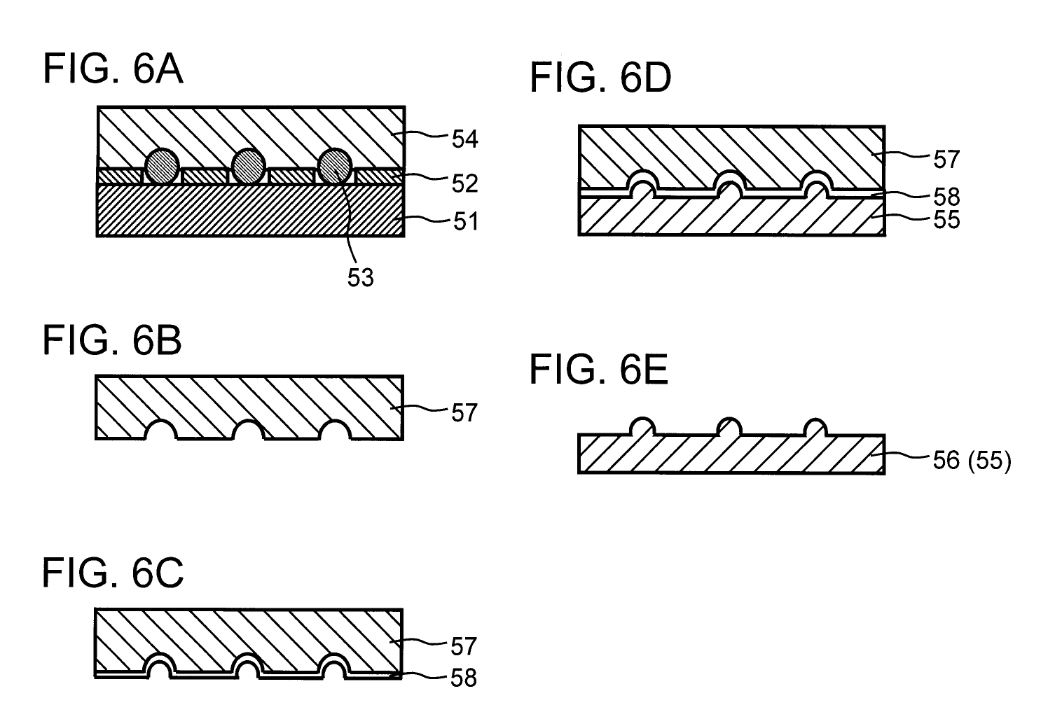

The method for transferring an arrangement of particles is not limited to a particular method, and may be appropriately selected for each purpose. As an example, a step of transferring a pattern is described below using Ni as a material for the formation of a stamper with reference to FIGS. 6A to 6E.

A film of a metal, such as Ni, is formed by vapor deposition on a layered product composed of a substrate 51, an arrangement of particles 53, and lands 52 (FIG. 3B or FIG. 4C). A metal layer 54 is then formed on the metal film by vapor deposition or plating (FIG. 6A). The metal layer 54 is then separated from the substrate 51, thus producing a mold 57 that has pits corresponding to the arrangement of particles 53 (FIG. 6B). Before the vapor deposition of the metal, a mold-release agent having a fluorinated organic molecule chain may be applied by coating or vapor deposition to the substrate 51 to facilitate the separation of the mold 57 from the substrate 51.

Particles remaining on the mold 57 having pits are removed by solvent treatment, for example, with xylene and ashing. The solvent treatment may be combined with ultrasonication to reduce the process time. The surface of the mold 57 is then oxidized by immersion in potassium permanganate or oxygen plasma ashing.

A metal layer 58 having a thickness approximately in the range of 10 to 50 nm is formed as a plating electrode by vapor deposition on the surface of the mold 57 to which the arrangement of particles is transferred (FIG. 6C). The metal layer 58 also serves as a contact surface in mold press, and therefore need to have a low resistance and high hardness. Thus, the metal layer 58 is formed of a high-hardness metal, such as Ni, Ti, or Cr. Among these, Cr is preferred because of the highest hardness.

A Ni layer 55 is then formed on the metal layer 58 by plating (FIG. 6D). The Ni layer 55 generally has a thickness in the range of 200 to 10,000 μm. The Ni layer 55 is then separated from the mold 57 having pits, thus producing a stamper 56 having a duplicate of the arrangement of particles 53 (FIG. 6E).

Thus, the arrangement of particles formed by the step of forming an arrangement of particles is transferred to a material for the formation of a stamper.

The height of protrusions of the stamper is not limited to a particular value, and may be appropriately selected for each purpose. When a nanohole structure formed with the stamper is used in a magnetic recording medium, such as a hard disk, the height of land is preferably at least 10 nm and more preferably in the range of 20 to 100 nm. The height of protrusions less than 10 nm results in an inadequate depth of starting points of nanoholes, which is formed in the transfer the shapes of the protrusions of the stamper to a surface of a metal film described below. In the formation of a nanohole by anodic oxidation described below, an electric current is not sufficiently concentrated on shallow starting points of nanoholes. Thus, the nanoholes may not be formed at predetermined positions. This disturbs the arrangement of nanoholes. When the ratio of the height of the protrusions to the space between protrusions (aspect ratio) of a stamper is too large, the lands may be deformed or broken during the transfer of a land and pit pattern to a nanohole structure. Preferably, the aspect ratio is 1.2 or less. A method for forming a nanohole structure using a stamper and a method for forming a magnetic recording medium using a stamper are described below.

### 2. Method for Manufacturing a Nanohole Structure

A method for manufacturing a nanohole structure according to the present embodiment includes the steps of forming a plurality of starting points of nanoholes using a stamper manufactured by the method for manufacturing a stamper, and performing a nanohole-forming treatment to the starting points of the nanoholes.

According to this method for manufacturing a nanohole structure, a stamper manufactured by the method for manufacturing a stamper can be used to form a nanohole structure having an intended nanohole pattern.

First, a nanohole structure according to the present embodiment will be described below.

The nanohole structure according to the present embodiment may be formed of any material and have any shape, structure, and size; these are appropriately determined for each purpose.

The material of a metal substrate forming the nanohole structure may be appropriately selected for each purpose, and may be a metal, a metal oxide, a metal nitride, or an alloy. Among these, alumina (aluminum oxide), aluminum, glass, and silicon may be preferred.

The metal substrate may be, but not limited to, plate-shaped or discoidal. In particular, when the nanohole structure is used for a magnetic recording medium, such as a hard disk, the metal substrate is preferably discoidal.

Nanoholes (pores) in a plate-shaped or discoidal metal substrate are formed approximately at right angles to a surface of the metal substrate.

A nanohole may be a through-hole passing through the nanohole structure or a pit that does not pass through the nanohole structure. When the nanohole structure is used for a magnetic recording medium, a nanohole is preferably a through-hole.

The structure of the metal substrate may be appropriately selected for each purpose, and may be a monolayer structure or a multilayer structure.

The size of the metal substrate is not limited to a particular size, and may be appropriately selected for each purpose. When the nanohole structure is used for a magnetic recording medium, such as a hard disk, the metal substrate preferably has a size matching the size of existing hard disks. When the nanohole structure is used for a DNA chip, the metal substrate preferably has a size matching the size of existing DNA chips. When the nanohole structure is used for a catalyst substrate, such as a carbon nanotube, for use in a field-emission apparatus, the metal substrate preferably has a size matching the size of the field-emission apparatus.

The arrangement of nanoholes is not limited to a particular arrangement, and is selected according to a predetermined final product. For example, the arrangement of nanoholes may be a plurality of arrangements of nanoholes parallel to each other, a concentric arrangement, or a spiral arrangement. When the nanohole structure is used for a DNA chip, the arrangement of nanoholes is preferably a plurality of arrangements of nanoholes parallel to each other. When the nanohole structure is used for a magnetic recording medium, such as a hard disk or a videodisc, a concentric or spiral arrangement is preferred. In particular, in a magnetic recording medium for use in a hard disk, a concentric arrangement is preferred in terms of accessibility, and in a magnetic recording medium for use in a videodisc, a spiral arrangement is preferred in terms of continuous playback.

The arrangement of nanoholes may be a regular arrangement or an irregular arrangement.

Each step in a method for manufacturing a nanohole structure according to the present embodiment will be described below.

First, a step of forming a starting point of nanohole will be described below.

Starting points of nanoholes are pits that serve as reference positions of nanoholes formed by a step of forming nanoholes described below. In the step of forming nanoholes, when nanoholes are formed by anodic oxidation, the required amount of electric current for anodic oxidation is concentrated on starting points of nanoholes, thus forming deeper holes at the starting points of nanoholes. These deeper holes are nanoholes.

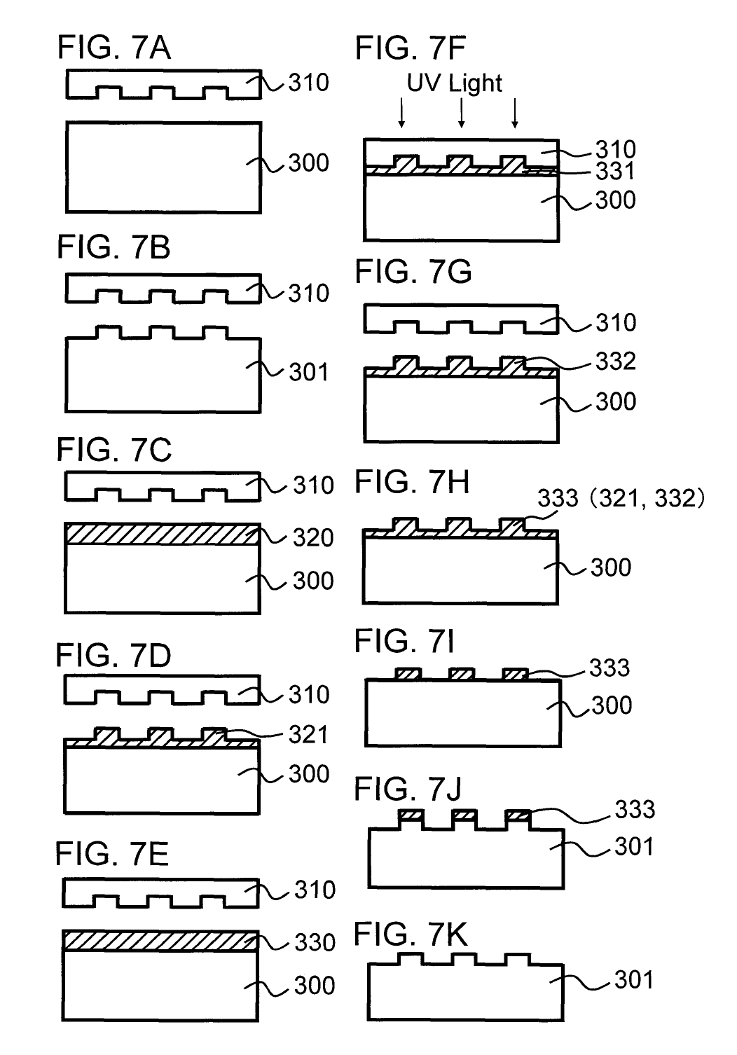

Examples of a method for forming starting points of nanoholes include direct imprint, thermal imprint, and photoimprint each using a stamper manufactured by the method for manufacturing a stamper. These methods will be described below with reference to FIGS. 7A to 7K.

A step of forming a starting point of nanohole on a metal substrate will be described below.

As illustrated in FIG. 7A, in a method for forming starting points of nanoholes by direct imprint, a stamper 310 is directly pressed against a metal substrate (for example, aluminum) 300 at a pressure in the range of 1×10³ to 5×10³ kg/cm² to form a metal substrate 301 having grooves illustrated in FIG. 7B. A material for the formation of a stamper preferably has high hardness, and is preferably a metal or SiC. In particular, a metal is preferred, because a metal stamper is easy to duplicate.

As illustrated in FIG. 7C, in a method for forming starting points of nanoholes by thermal imprint, a thermoplastic polymer layer 320, for example, formed of a resist or PMMA, is formed on a metal substrate 300. A stamper 310 is pressed against the thermoplastic polymer layer 320 at a temperature above the softening point of the polymer (about 100° C. to 200° C.) and a medium pressure (50 to 1000 kg/cm²) to form a thermoplastic polymer layer 321 having pits illustrated in FIG. 7D. A material for the formation of a stamper preferably has high hardness or medium hardness and heat resistance, and is preferably a metal, Si, SiC, or SiO₂. In particular, a metal is preferred, because a metal stamper is easy to duplicate.

As illustrated in FIG. 7E, in a method for forming a starting point of nanohole by photoimprint, a photopolymer layer 330 is formed on a metal substrate 300. As illustrated in FIG. 7F, a stamper 310 is then pressed against the photopolymer layer 330 under reduced pressure. The photopolymer layer 330 is irradiated with ultraviolet light through the stamper 310 to form a patterned photopolymer layer 331. As illustrated in FIG. 7G, a photopolymer layer 332 having pits is separated from the stamper 310. The material for the formation of a stamper need to pervious to ultraviolet light, and is therefore preferably transparent. For example, SiO₂ or a polymer may be preferred. A polymer is particularly preferred, because a polymer stamper is easy to duplicate.

In the thermal imprint method and the photoimprint method, as illustrated in FIG. 7H, the following treatment is performed to the metal substrate 300 which includes the thermoplastic polymer layer 321 or the photopolymer layer 332 each having pits (hereinafter referred to generally as polymer layer 333). As illustrated in FIG. 7I, after the polymer remaining in the pits of the polymer layer 333 is removed, for example, by O₂ plasma ashing, the metal substrate 300 is subjected to chlorine dry etching or hydrochloric acid wet etching to form a layered product illustrated in FIG. 7J. The layered product includes a metal substrate 301 having pits and polymer layers 333. Finally, as illustrated in FIG. 7K, the polymer layers 333 are removed with a solvent to form the metal substrate 301 having pits.

A step of forming nanoholes on a metal substrate will be described below.

A nanohole-forming treatment is not limited to a particular treatment, and may be appropriately selected for each purpose. Examples of the nanohole-forming treatment include anodizing and etching. In particular, anodizing is preferred, because anodizing can selectively form a nanohole at a starting point of nanohole in a metal substrate.

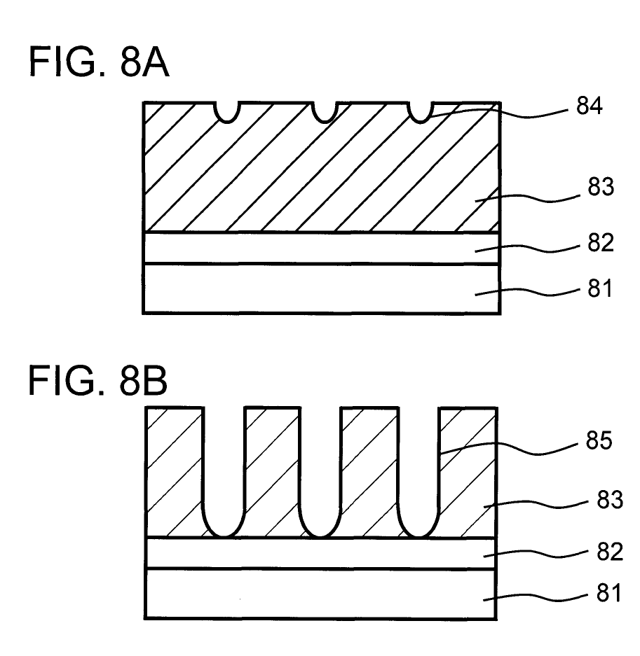

FIGS. 8A and 8B are schematic cross-sectional views of a step of forming nanoholes on a metal substrate by anodizing.

As illustrated in FIG. 8A, in anodizing, an electrode layer 82 is formed on a substrate 81. A metal layer 83 is formed on the electrode layer 82, thus forming a metal substrate 300. The metal layer 83 has starting points of nanohole 84 in the surface. As illustrated in FIG. 8B, the metal substrate 300 is electrolytically etched in an electrolyte to form nanoholes 85 at the starting points of nanoholes. The electrode layer 82 functions as an anode. The material of the electrode layer 82 may be the same as that used in a method for manufacturing a magnetic recording medium described below. The cathode may be any electrode, including carbon. An additional layer may be present between the substrate 81 and the electrode layer 82.

The anodizing voltage is generally, but not limited to, in the range of 3 to 40 V.

The type and the concentration of the electrolyte, and the temperature and the time of anodizing may be appropriately selected according to the number, the size, and the aspect ratio of the nanoholes 85. Preferred examples of the electrolyte include a diluted phosphoric acid solution, a diluted oxalic acid solution, and a diluted sulfuric acid solution. The aspect ratio of the nanoholes 85 is controlled by increasing the diameter of the nanoholes (alumina pores) 85 by dipping the metal substrate 300 in a phosphoric acid solution after anodizing.

Thus, the resulting porous layer (nanohole structure) includes a plurality of nanoholes 85 in the metal substrate 300.

The nanohole structure manufactured by this step can be suitably used for hard disk drives used as external storages of computers or home video recorders in various applications, including magnetic recording media, DNA chips, and catalyst substrates.

### 3. Method for Manufacturing a Magnetic Recording Medium

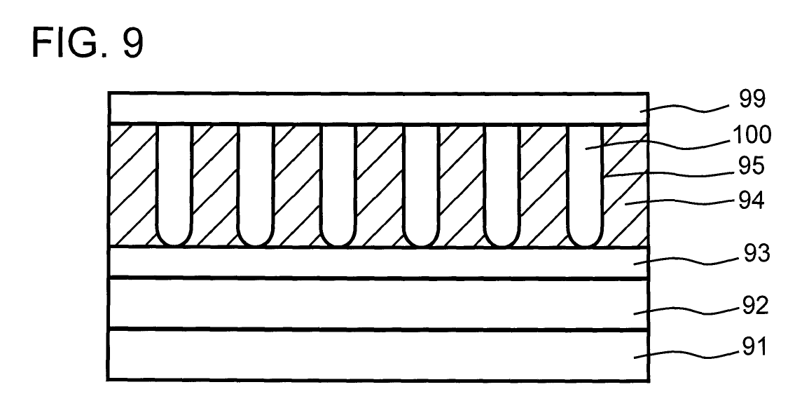

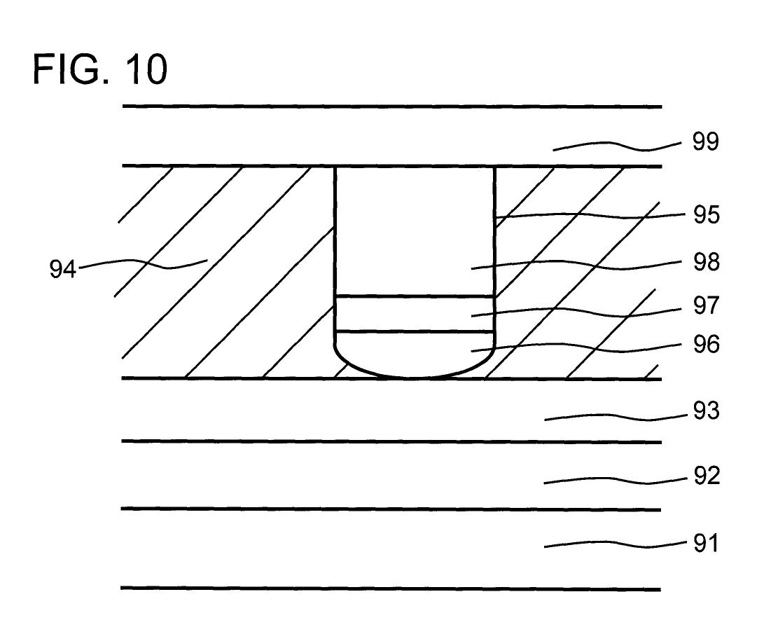

FIG. 9 is a schematic cross-sectional view of a magnetic recording medium manufactured by a method for manufacturing a magnetic recording medium according to an embodiment. A soft-magnetic underlayer 92, an electrode layer 93, and a metal layer 94 are formed on a substrate 91. Nanoholes 95 are formed in the metal layer 94. The nanoholes 95 are filled with a magnetic recording material. FIG. 10 is an enlarged schematic cross-sectional view of the magnetic recording medium illustrated in FIG. 9. The nanoholes 95 are filled with a soft-magnetic layer 96, a nonmagnetic layer 97, and a ferromagnetic layer 98 from the bottom. The surface of the metal layer 94 is flush with the surface of the ferromagnetic layer 98. A protective layer 99 is formed on the metal layer 94 and the ferromagnetic layer 98.

In a method for manufacturing a magnetic recording medium according to the present embodiment, in which the magnetic recording medium includes a plurality of nanoholes filled with a magnetic material on a substrate, the method includes the steps of forming starting points of nanohole on the substrate using a stamper manufactured by the method for manufacturing a stamper, forming a plurality of nanoholes at the starting points of nanoholes in the substrate, and filling the nanoholes with the magnetic material.

According to this method for manufacturing a magnetic recording medium, a stamper manufactured by the method for manufacturing a stamper can be used to form a patterned medium having an intended magnetic film pattern.

Preferably, the method for manufacturing a magnetic recording medium according to the present embodiment further includes a polishing step. If necessary, the method for manufacturing a magnetic recording medium according to the present embodiment further includes the steps of forming a soft-magnetic underlayer, forming an electrode layer, forming a soft-magnetic layer, forming a nonmagnetic layer, and/or forming a protective layer.

The steps of a method for manufacturing a magnetic recording medium according to the present embodiment will be described below.

### (Step of Forming Starting Points of Nanoholes)

The following describes a step in which a stamper manufactured by the method for manufacturing a stamper is used to form starting points of nanoholes on a substrate.

In the step of forming starting points of nanoholes, a metal layer is formed on a substrate (or on a soft-magnetic underlayer if the soft-magnetic underlayer is formed by a step of forming a soft-magnetic underlayer, or on an electrode layer if the electrode layer is formed by a step of forming an electrode layer). Starting points of nanoholes are then formed in the metal layer with a stamper. The substrate including the metal layer may be considered as a “metal substrate”.

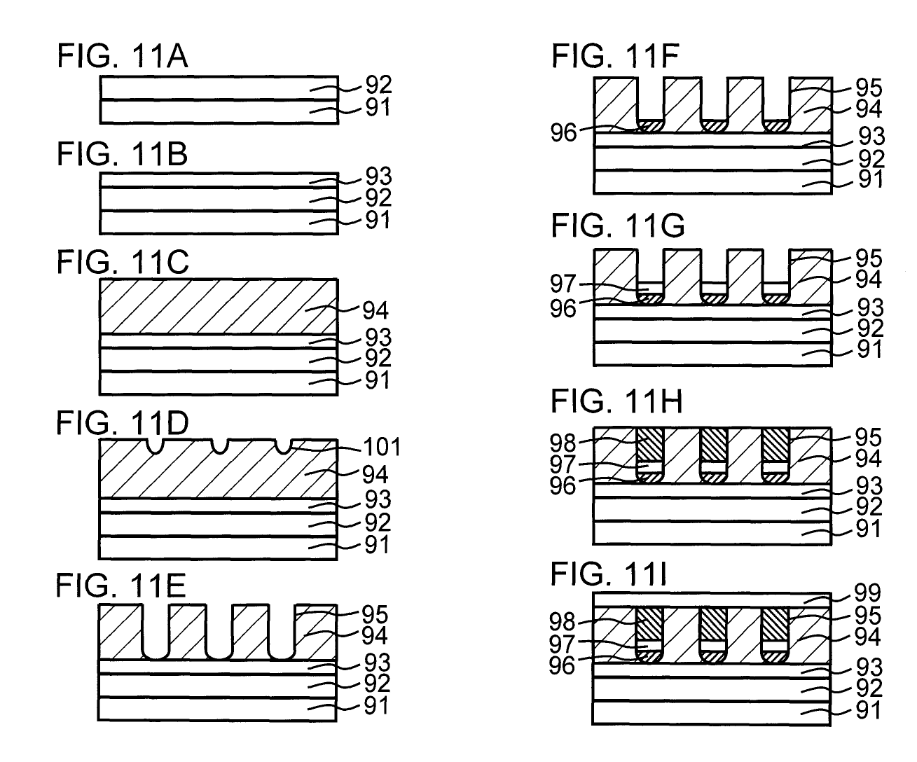

FIGS. 11A to 11I are schematic cross-sectional views of a process for manufacturing a magnetic recording medium according to the present embodiment.

First, as illustrated in FIG. 11A, a soft-magnetic underlayer 92 is formed on a substrate 91 in the step of forming a soft-magnetic underlayer. The step of forming a soft-magnetic underlayer is an optional step in which a soft-magnetic underlayer is formed on a substrate.

The substrate of a magnetic recording medium may have any shape, any structure, and any size, and may be formed of any material. The substrate may be appropriately selected for each purpose. For example, when the magnetic recording medium is a magnetic disk, such as a hard disk, the substrate is discoidal. The structure of the substrate may be a monolayer structure or a multilayer structure. The material of the substrate may be any known material of a substrate of a magnetic recording medium, including aluminum, glass, silicon, quartz, and SiO₂/Si, in which a thermally oxidized film is formed on silicon. These materials may be used alone or in combination.

The soft-magnetic underlayer may be formed on the substrate by any known method, including sputtering, vacuum deposition such as vapor deposition, electrodeposition, and electroless plating.

A soft-magnetic underlayer having a predetermined thickness is formed on the substrate by the step of forming a soft-magnetic underlayer.

As illustrated in FIG. 11B, an electrode layer 93 is formed on the soft-magnetic underlayer 92 in the step of forming an electrode layer.

An electrode layer may be formed by any known method, including sputtering and vapor deposition. The conditions for forming an electrode layer are not limited to particular conditions, and may be appropriately selected for each purpose.

An electrode layer formed by the step of forming an electrode layer may be used as an electrode when at least one of a soft-magnetic layer, a nonmagnetic layer, and a ferromagnetic layer is formed on the substrate by electrodeposition.

As illustrated in FIG. 11C, a metal layer 94 is formed on the electrode layer 93 by the step of forming a metal layer. The material of the metal layer 94 may be, but not limited to, alumina (aluminum oxide) or aluminum, preferably aluminum.

A metal layer may be formed by any known method, including sputtering and vapor deposition. The conditions for forming a metal layer are not limited to particular conditions, and may be appropriately selected for each purpose. In sputtering, the material of a metal layer is used as a target. The target is preferably of high purity. For example, an aluminum target preferably has a purity of at least 99.990%.

As illustrated in FIG. 11D, starting points of nanohole 101 are then formed in the metal layer 94.

Starting points of nanoholes may be formed by the method described in the method for manufacturing a nanohole structure.

### (Step of Forming Nanoholes)

The following describes a step of forming a plurality of nanoholes at starting points of nanoholes.

In a step of forming a plurality of nanoholes, after the step of forming starting points of nanoholes, a plurality of nanoholes are formed at starting points of nanoholes in a metal layer by nanohole-forming treatment approximately at right angles to a surface of a substrate, thus forming a nanohole structure (porous layer). More specifically, as illustrated in FIG. 11E, nanoholes 95 reaching the substrate 91, the soft-magnetic underlayer 92, or the electrode layer 93 are formed at the starting points of the nanoholes 101 in the metal layer 94 illustrated in FIG. 11D.

The nanohole-forming treatment may be appropriately selected for each purpose, and may be, but not limited to, anodizing or etching. In particular, anodizing is preferred, because anodizing can regularly form many nanoholes at starting points of nanoholes in a metal layer approximately at right angles to a surface of a substrate.

In anodizing, a metal layer is electrolytically etched in an aqueous solution of sulfuric acid, phosphoric acid, or oxalic acid using an electrode in contact with the metal layer as an anode. The electrode may be a soft-magnetic underlayer or an electrode layer formed before the formation of the metal layer.

The anodizing voltage is generally, but not limited to, in the range of 3 to 40 V.

The type and the concentration of the electrolyte, and the temperature and the time of anodizing may be appropriately selected according to the number, the size, and the aspect ratio of nanoholes. Preferred examples of the electrolyte include a diluted phosphoric acid solution, a diluted oxalic acid solution, and a diluted sulfuric acid solution. The aspect ratio of nanoholes is controlled by increasing the diameter of nanoholes (alumina pores) by dipping the metal substrate in a phosphoric acid solution after anodizing.

While many nanoholes can be formed in a metal layer by anodizing, a barrier layer may be formed in a lower part of the nanoholes. However, the barrier layer may be easily removed by a known etching process using a known etchant, such as phosphoric acid.

Thus, many nanoholes reaching a soft-magnetic underlayer or a substrate can be formed in a metal layer approximately at right angles to a surface of a substrate.

### (Step of Filling a Nanohole With a Magnetic Material)

The following describes a step of filling nanoholes with a magnetic material.

In the step of filling nanoholes with a magnetic material, nanoholes formed by the step of forming nanoholes is filled with a magnetic material. The step of filling nanoholes with a magnetic material includes a substep of filling nanoholes with a ferromagnetic material and a substep of filling the nanoholes with a soft-magnetic material. These substeps will be described below.

As illustrated in FIG. 11F, soft-magnetic layers 96 are formed within the nanoholes 95 by a substep of forming a soft-magnetic layer. A soft-magnetic layer may be formed by depositing or charging a soft-magnetic material in each nanohole, for example, by electrodeposition.

The conditions for electrodeposition are not limited to particular conditions, and may be appropriately selected for each purpose. For example, at least one solution containing a soft-magnetic material is used to precipitate or deposit the soft-magnetic material on a soft-magnetic underlayer or an electrode layer, which functions as an electrode, through the application of a voltage.

In the substep of forming a soft-magnetic layer, a soft-magnetic layer is formed in nanoholes on a substrate, a soft-magnetic underlayer, or an electrode layer.

As illustrated in FIG. 11G, nonmagnetic layers 97 are formed on the soft-magnetic layers 96 by the substep of forming a nonmagnetic layer. A nonmagnetic layer may be formed on a soft-magnetic layer in nanoholes by depositing or charging a nonmagnetic material, for example, by electrodeposition. The conditions for electrodeposition are not limited to particular conditions, and may be appropriately selected for each purpose. For example, at least one solution containing a nonmagnetic material is used to precipitate or deposit the nonmagnetic material in nanoholes through the application of a voltage using a soft-magnetic underlayer or an electrode layer as an electrode. In the substep of forming a nonmagnetic layer, a nonmagnetic layer is formed on a soft-magnetic layer in nanoholes in a porous layer.

As illustrated in FIG. 11H, ferromagnetic layers 98 are then formed on the nonmagnetic layers 97 by a substep of forming a ferromagnetic layer. If the nonmagnetic layers 97 are not formed on the soft-magnetic layers 96, the ferromagnetic layers 98 are formed on the soft-magnetic layers 96.

A ferromagnetic layer may be formed on a soft-magnetic layer in a nanohole by depositing or charging a ferromagnetic material, for example, by electrodeposition. The method of electrodeposition is not limited to particular method, and may be appropriately selected for each purpose. For example, at least one solution containing a ferromagnetic material is used to precipitate or deposit the ferromagnetic material in nanoholes through the application of a voltage using a soft-magnetic underlayer or an electrode layer (seed layer) as an electrode. In the substep of forming a ferromagnetic layer, a ferromagnetic layer is formed on a soft-magnetic layer or a nonmagnetic layer in a nanohole.

A method for manufacturing a magnetic recording medium according to the present embodiment may further include a polishing step of polishing the surface of the metal layer 94 and the ferromagnetic layers 98 after the formation of the ferromagnetic layers 98. In the polishing step, the surface of a nanohole structure (porous layer) is polished for planarization. Removal of a surface having a predetermined thickness from a nanohole structure in the polishing step ensures high-density and high-speed recording. A polished surface of a magnetic recording medium allows a magnetic head, such as a perpendicular magnetic recording head, to float stably and closely over the magnetic recording medium, thus ensuring high-density recording and reliability.

Preferably, the polishing step follows a step of forming a magnetic layer (including a substep of forming a ferromagnetic layer and a substep of forming a soft-magnetic layer). Polishing before the step of forming a magnetic layer may cause a fracture in the nanohole structure or contamination of a nanohole with slurry or shavings, which results in plating defects.

The method of polishing in the polishing step may be any known method and is preferably, but not limited to, CMP or ion milling.

As illustrated in FIG. 11I, a protective layer 99 is formed on the metal layer 94 and the ferromagnetic layers 98 by the substep of forming a protective layer.

A protective layer protects a ferromagnetic layer, and is formed on or over the ferromagnetic layer. The protective layer may be a monolayer or a multilayer. The material of the protective layer may be appropriately selected for each purpose, and may be, but not limited to, diamond-like carbon (DLC).

The thickness of the protective layer is not limited to a particular thickness, and may be appropriately selected for each purpose. The protective layer may be formed by any known method, including plasma CVD and coating.

The present invention is not limited to the embodiments described above. The embodiments described above are provided only for illustrative purposes. Other embodiments that are based on substantially the same technical idea as that described in the claims of the present invention and that have substantially the same operational advantages as those of the present invention are within the technical scope of the present invention.

According to a method for manufacturing a stamper according to the embodiments described above, a substrate having a land and groove pattern can maintain the land and groove pattern in a dipping process of the substrate in a liquid of a suspension of particles. This results in a consistent arrangement of particles in lands and grooves of the substrate, and therefore a consistent structure of the resulting stamper.

According to a method for manufacturing a nanohole structure according to the embodiments described above, a stamper manufactured by the method for manufacturing a stamper can be used to form a porous layer having an intended nanohole pattern.

According to a method for manufacturing a magnetic recording medium according to the embodiments described above, a stamper manufactured by the method for manufacturing a stamper can be used to form a patterned medium having an intended magnetic film pattern.

### Experiment 1

A PMMA resin solution was applied by spin coating to a Si wafer substrate (diameter 6.3 cm) having an oxide film thereon. The substrate was heated at 80° C. for 30 minutes to vaporize the solvent so as to form a resin layer. The substrate having the resin layer was then heated above the glass transition temperature of the resin. A first mold was pressed against the substrate to transfer the mold pattern. The first mold had a land and groove pattern at intervals of 150 nm (the half-width of land was 50 nm, and the distance between adjacent lands was 100 nm). The grooves had a depth of 100 nm. The substrate having the resin layer having land and groove pattern was then etched by oxygen plasma ashing to remove the resin at the grooves, thus exposing the oxide film.

The land and groove pattern of the resin layer on the substrate was coated with Si having a thickness of 20 nm by vapor deposition. The substrate was then dipped in acetone to remove the resin lands, together with Si disposed thereon, thus leaving the lands formed of Si.

The substrate having the Si lands was dipped in a liquid of a suspension of nanoparticles (Polysciences, Inc., trade name “NIST Traceable Precision Particle Size Standards, 64010-15”), and was pulled up at a speed of 0.04 mm/min. The liquid of the suspension contains polystyrene particles having a size of 100 nm. It took 20 hours to pull up the substrate. The particles were arranged in the grooves on the oxide film.

The particles and the Si lands were coated with Ni by vapor deposition. The Ni film was then coated with a Ni layer by plating. The Ni layer was separated from the substrate, thus forming a second mold to which the pattern of the particles and the Si lands was transferred.

The second mold was washed with xylene to remove particles remaining on the surface thereof. The second mold was then oxidized by dipping in potassium permanganate or oxygen plasma ashing.

The second mold was coated with Ni by vapor deposition. The resulting Ni film was then coated with a Ni layer by plating. The Ni layer was separated from the second mold to form a stamper according to Experiment 1. Before dipping in the liquid of the suspension of nanoparticles, the lands formed on the Si substrate had a half-width of 80 nm and a height of 20 nm.

### Experiment 2

A stamper according to Experiment 2 was formed as in Experiment 1, except that a first mold had a land and groove pattern at intervals of 200 nm (the half-width of land was 100 nm, and the distance between adjacent lands was 100 nm). Before dipping in the liquid of the suspension of nanoparticles, the lands formed on the Si substrate had a half-width of 100 nm and a height of 20 nm.

### Comparative Experiment 1

A PMMA resin solution was applied by spin coating to a Si wafer substrate (diameter 6.3 cm) having an oxide film thereon. The substrate was heated at 80° C. for 30 minutes to vaporize the solvent so as to form a resin layer. The substrate having the resin layer was then heated above the glass transition temperature of the resin. A first mold was pressed against the substrate to transfer the mold pattern. The first mold had a land and groove pattern at intervals of 150 nm (the half-width of land was 100 nm, and the distance between adjacent lands was 50 nm). The grooves had a depth of 100 nm. The substrate having the resin layer having the land and groove pattern was then etched by oxygen plasma ashing to remove the resin at the grooves, thus forming resin lands.

The substrate having the resin lands was dipped in a liquid of a suspension of nanoparticles (Polysciences, Inc., trade name “NIST Traceable Precision Particle Size Standards, 64010-15”), and was pulled up at a speed of 0.04 mm/min. The liquid of the suspension contains polystyrene particles having a size of 100 nm. It took 20 hours to pull up the substrate. The particles were arranged in the grooves on the oxide film.

The particles and the Si lands were coated with Ni by vapor deposition. The Ni film was then coated with a Ni layer by plating. The Ni layer was separated from the substrate, thus forming a second mold to which the pattern of the particles and the Si lands was transferred.

The second mold was washed with xylene to remove particles remaining on the surface thereof. The second mold was then oxidized by dipping in potassium permanganate or oxygen plasma ashing.

The second mold was coated with Ni by vapor deposition. The resulting Ni film was then coated with a Ni layer by plating. The Ni layer was separated from the second mold to form a stamper according to Comparative Experiment 1. Before dipping in the liquid of the suspension of nanoparticles, the resin lands formed on the Si substrate had a half-width of 80 nm and a height of 20 nm.

### Comparative Experiment 2

A stamper according to Comparative Experiment 2 was formed as in Comparative Experiment 1, except that a first mold had a land and groove pattern at intervals of 200 nm (the half-width of land was 100 nm, and the distance between adjacent lands was 100 nm). Before dipping in the liquid of the suspension of nanoparticles, the resin lands formed on the Si substrate had a half-width of 100 nm and a height of 70 nm.

### (Evaluation)

In Experiments and Comparative Experiments, the lands of the substrate were observed with an atomic force microscope (AFM) (Digital Instruments Co., trade name “NanoScope”) before and after dipping in the liquid of the suspension of nanoparticles. The mean half-width and the mean height of the lands were determined from four observations.

### (Evaluation Results)

In Experiment 1 and Experiment 2, no change in the shape of the lands was observed after dipping in the liquid of the suspension of the nanoparticles. By contrast, in Comparative Experiment 1, the half-width of the resin lands was reduced by 60% after dipping in the liquid of the suspension of nanoparticles. Furthermore, the height of the resin lands was reduced by 50% after dipping in the liquid of the suspension of nanoparticles. In Comparative Experiment 2, no change in the half-width of the resin lands was observed after dipping in the liquid of the suspension of nanoparticles. The height of the resin lands was reduced by 20% after dipping in the liquid of the suspension of nanoparticles.

What is claimed is:

1. A method for manufacturing a stamper for duplicating a pit pattern on a substrate, the method comprising:
forming on another substrate, a layer of a material insoluble to a liquid of a suspension of particles in a pattern having a plurality of land portions and a plurality of groove portions between the land portions;
dipping the another substrate having the layer of the material having the pattern in the liquid of the suspension of the particles so that the particles are adhered to the groove portions;
forming a mold having a plurality of pits corresponding to the particles by transferring the shapes of the particles on the another substrate to the mold; and
forming a stamper having a plurality of protrusions corresponding to the pits by transferring the shapes of the pits of the molds to the stamper.

2. The method according to claim 1, wherein the land portions contain at least one material selected from the group consisting of Si, silicon oxide, silicon nitride, silicon carbide, metals, metal oxides, metal nitrides, and metal carbides.

3. The method according to claim 1, wherein the land portions have a half-width of 80 nm or less.

4. The method according to claim 1, wherein the another substrate is formed of Si or silicon oxide and the land portions are formed of Si or silicon oxide.

5. The method according to claim 1, wherein the another substrate is formed of silicon oxide and the land portions are formed of Si.

6. The method according to claim 1, wherein the particles contain silicon oxide.

7. The method according to claim 1, wherein the arrangement of the particles is formed on the groove portions.

8. The method according to claim 1, wherein forming the layer on the another substrate comprises:
forming a first member over the another substrate;
forming a first pattern having a plurality of land portions and a plurality of groove portions between the land portions on the first member;
forming a second member on the another substrate so that the groove portions is filled with the second member; and
removing the first member from the another substrate so as to form the pattern consisting of the second member over the another substrate.

9. The method according to claim 1, wherein forming the layer on the another substrate comprises:
providing another mold having a plurality of land portions and a plurality of groove portions between the land portion of the mold;
forming a resin layer having a plurality of land portions and a plurality of groove portions by transferring shapes of the another mold to the resin layer, the shapes of the resin layer corresponding to the shapes of the another mold;
removing the resin from the bottom of the groove portions of the resin layer;
forming the layer on the resin layer so that the groove portions of the resin layer are filled with the material; and
removing the resin layer so as to form the layer in the pattern.

10. The method according to claim 9, wherein removing the resin layer at the groove portions of the resin layer is conducted by etching.

11. The method according to claim 9, wherein removing the resin layer so as to form the layer in the pattern is done by a lift-off method so that the resin layer and the layer over the resin layer are removed.

12. The method according to claim 9, further comprising:
polishing the layer by the method of chemical mechanical polishing so that the resin layer is exposed.

13. The method according to claim 1, further comprising:
applying a mold-release agent to the particles on the another substrate.

14. The method according to claim 1, wherein dipping the another substrate having the layer of the material having the pattern in the liquid of the suspension of the particles so that the particles are adhered to the groove portions on the surface comprises:
dipping the another substrate in the liquid; and
pulling up the another substrate dipped in the liquid so that the particles are adhered to the groove portions.

15. The method according to claim 1, wherein forming a mold having a plurality of pits corresponding to the particles by transferring the shapes of the particles on the another substrate to the mold comprises:
forming the mold of metal on the another substrate on which the particles are arranged so that the arrangement of the particles as the reverse is formed on the mold; and
removing the mold from the another substrate.

16. The method according to claim 1, wherein forming a stamper having a plurality of protrusions corresponding to the pits by transferring the shapes of the pits of the molds to the stamper comprises:
forming the stamper on the mold so that the arrangement of the particles is formed on the stamper;
removing the stamper from the mold.

17. A method for manufacturing a nanohole structure comprising:
imprinting a plurality of pits using a stamper for duplicating a pit pattern on a substrate obtained by:
forming on another substrate, a layer of a material insoluble to a liquid of a suspension of particles in a pattern having a plurality of land portions and a plurality of groove portions between the land portions;
dipping the another substrate having the layer of the material having the pattern in the liquid of the suspension of the particles so that the particles are adhered to the groove portions;
forming a mold having a plurality of pits corresponding to the particles by transferring the shapes of the particles on the another substrate to the mold; and
forming a stamper having a plurality of protrusions corresponding to the pits by transferring the shapes of the pits of the molds to the stamper; and
forming a plurality of nanoholes by forming treatment of the pits, the nanoholes being larger than the pits.

18. A method for manufacturing a magnetic recording medium comprising:
imprinting a plurality of pits using a stamper for duplicating a pit pattern on a substrate obtained by:
forming on another substrate, a layer of a material insoluble to a liquid of a suspension of particles in a pattern having a plurality of land portions and a plurality of groove portions between the land portions;
dipping the another substrate having the layer of the material having the pattern in the liquid of the suspension of the particles so that the particles are adhered to the groove portions;
forming a mold having a plurality of pits corresponding to the particles by transferring the shapes of the particles on the another substrate to the mold; and
forming a stamper having a plurality of protrusions corresponding to the pits by transferring the shapes of the pits of the molds to the stamper;
forming a plurality of nanoholes by a forming treatment of the pits, the nanoholes being larger than the pits; and
filling the nanoholes with a magnetic material.
